(19) United States
(12) Patent Application Publication
(10) Pub. No.: US 2012/0118653 A1
(43) Pub. Date: May 17, 2012

(54) IN-VEHICLE ELECTRONIC COMPONENT DISPOSING CONSTRUCTION FOR ELECTRONIC COMPONENT FOR ELECTRIC MOTOR FOR DRIVING VEHICLE

(75) Inventors: Yasushi Ogihara, Saitama (JP); Harumi Takedomi, Saitama (JP)

(73) Assignee: HONDA MOTOR CO., LTD., Tokyo (JP)

(21) Appl. No.: 13/387,675

(22) PCT Filed: Jul. 28, 2010
(86) PCT No.: PCT/JP2010/062728

§ 371 Date: Jan. 27, 2012

(30) Foreign Application Priority Data
Jul. 28, 2009 (JP) 2009-175737

(51) Int. Cl. B60K 1/00

(52) U.S. Cl. 180/65.8

(57) ABSTRACT

There is provided an in-vehicle electronic component disposing construction for fixing an electronic component strongly and rigidly to a vehicle body while ensuring a sufficient space within a passenger compartment and realizing a reduction in weight of the construction. An electronic component box containing electronic components and disposed between a driver's seat and a front passenger's seat is supported by a floor panel of a vehicle and a steering system hanger beam to which a steering system is fixed.

### TECHNICAL FIELD

The present invention relates to an in-vehicle electronic component disposing construction for disposing an electronic component for an electric motor for driving a vehicle between a driver's seat and a front passenger's seat.

### BACKGROUND ART

Conventionally, as a construction for mounting a battery in a vehicle, there has been devised a battery mounting construction in which a battery is disposed in a center console box lying between a driver's seat and a front passenger's seat and the center console box is adapted to move freely in a front-to-rear direction by rails (refer to Patent Document 1, for example).

### RELATED ART DOCUMENT

### Patent Document

Patent Document 1: JP-A-2008-149752

### SUMMARY OF INVENTION

### Problem that Invention is to Solve

Incidentally, when an electronic component for an electric motor for driving a vehicle, such as a battery, is disposed in a center console box, the battery needs to be fixed strongly and rigidly to a vehicle body in consideration of a lateral inertial force or collision. In order to fix the electronic component to the vehicle body strongly and rigidly, the center console box needs to be expanded in a widthwise or widthwise direction or a frame for fixing the electronic component to a floor needs to be made thick, leading to a problem that the driver's seat and the front passenger's seat become narrow in width or the weight of the vehicle is increased. These problems become more conspicuous in Patent Document 1 in which the battery is guided on the floor by the rails.

The invention has been made in view of these situations, and an object thereof is to provide an in-vehicle electronic component disposing construction for fixing an electronic component for an electric motor for driving a vehicle strongly and rigidly to a vehicle body while ensuring a sufficient space within a passenger compartment and realizing a reduction in weight of the construction.

### Means for Solving Problem

With a view to attaining the object, according to an invention set forth in Claim 1, there is provided an in-vehicle electronic component disposing construction including:

a steering system (for example, a steering system 37 in an embodiment which will be described later) which controls a vehicle (for example, a vehicle 1 in the embodiment);

a driver's seat (for example, a driver's seat 5a in the embodiment) and a front passenger's seat (for example, a front passenger's seat 5b in the embodiment) which are placed in a passenger compartment; and

an electronic component (for example, a battery unit 21, an inverter unit 22 and a DC-DC converter unit 23 in the embodiment) for an electric motor for driving the vehicle which is disposed between the driver's seat and the front passenger's seat, wherein

the electronic component is supported by a floor panel (for example, a floor panel 11 in the embodiment) of the vehicle and a beam (for example, a steering system hanger beam 31 in the embodiment) for fixing the steering system.

According to an invention set forth in Claim 2, there is provided an in-vehicle electronic component disposing construction as set forth in Claim 1, wherein

the electronic component is disposed in an interior of a frame (for example, IPU frames 50, 50 in the embodiment) which is fixed to the floor panel, and

the frame and the beam are fixed to each other by an extending portion (for example, stays 38, 38 in the embodiment) which extends at least from one of part of the beam and part of the frame.

According to an invention set forth in Claim 3, there is provided an in-vehicle electronic component disposing construction as set forth in Claim 2, wherein

the frame is fixed to a cross member (for example, cross members 14, 14 of the embodiment) which is connected to left and right side sills (for example, side sills 13, 13 in the embodiment) of the floor panel or fixed to a portion of a center tunnel (for example, a center tunnel 12 in the embodiment) of the floor panel which lies in a vicinity of the cross member.

According to an invention set forth in Claim 4, there is provided an in-vehicle electronic component disposing construction as set forth in Claim 2 or 3, wherein

the extending portion includes a couple of stays which extend substantially parallel to each other,

a user-operable electronic component (for example, a car navigation unit 60 and an audio unit 61 in the embodiment) which is to be operated by a user (a driver or a front-seat passenger) is disposed in a space (for example, a space portion S in the embodiment) which is defined by the beam, the couple of stays and a front upper edge portion of the electronic component for the vehicle driving electric motor, and

the user-operable electronic component is fixed to the beam via the couple of stays.

According to an invention set forth in Claim 5, there is provided a power control unit (for example, an integrated power unit: IPU) which is mounted in a vehicle including a driving electric motor, including: an electronic component (for example, a battery unit 21, an inverter unit 22 and a DC-DC converter unit 23 in an embodiment which will be described later) for controlling the electric motor; an electronic component box (for example, an electronic component box 20 in the embodiment) which accommodates the electronic component; and a fixing member (for example, an IPU frame 50) which fixes the electronic component box to the vehicle. The fixing member includes a first fixing portion (for example, a front lower fastening portion 55, a rear lower fastening portion 57) which is fixed to a floor panel of the vehicle in a position below the electronic component box and a second fixing portion (for example, a front upper fastening portion 56) which is fixed to a steering system hanger beam (for example, a steering system hanger beam 31) which extends in a widthwise direction of the vehicle in a position above the electronic component box.

According to an invention set forth in Claim 6, there is provided a power control unit as set forth in Claim 5, wherein

the second fixing portion is fixed to the steering system hanger beam via a couple of stays which extend downwards from a central portion of the steering system hanger beam in the widthwise direction of the vehicle.

According to an invention set forth in Claim 7, there is provided a power control unit as set forth in Claim 5, wherein

the first fixing portion includes a front fixing portion which is fixed to the floor panel in a position lying at a front of the electronic component box and a rear fixing portion which is fixed to the floor panel in a position lying at a rear of the electronic component box.

According to an invention set forth in Claim 8, there is provided a power control unit as set forth in Claim 7, wherein

the fixing member includes a frame which connects the front fixing portion, the rear fixing portion and the second fixing portion together.

According to an invention set forth in Claim 9, there is provided a power control unit as set forth in Claim 8, wherein

the frame includes a first frame portion which connects the front fixing portion and the second fixing portion together, a second frame portion which extends horizontally from the second fixing portion to a rear upper end position of the electronic component box, and a third frame portion which is bent from the rear upper end position to extend to the rear fixing portion.

According to an invention set forth in Claim 10, there is provided a power control unit as set forth in Claim 9, wherein

the fixing member includes a sub-frame which connects the first frame portion and the third frame portion together.

According to an invention set forth in Claim 11, there is provided a power control unit as set forth in Claim 8, wherein

the front fixing portion includes a first bolt fastening hole which is fixed to the floor panel by a first bolt being inserted thereinto in a first inserting direction, and

the rear fixing portion includes a second bolt fastening hole which is fixed to the floor panel by a second bolt being inserted thereinto in a second inserting direction which differs from the first inserting direction.

According to an invention set forth in Claim 12, there is provided a power control unit as set forth in Claim 5, wherein

the electronic component box is placed on the floor panel in such an orientation that a longitudinal direction of the electronic component box coincides with a front-to-rear direction of the vehicle.

According an invention set forth in Claim 13, there is provided a power control unit as set forth in Claim 12, wherein

the electronic component box is placed on a center tunnel which is formed along the front-to-rear direction of the vehicle in a central position of the floor panel in the widthwise direction of the vehicle.

According to an invention set forth in Claim 14, there is provided a power control unit as set forth in Claim 13, wherein

the first fixing portion is fixed to the center tunnel which is formed on the floor panel.

According to an invention set forth in Claim 15, there is provided a power control unit as set forth in Claim 14, wherein

the first fixing portion is fixed to the center tunnel in a position lying in a vicinity of a cross member which connects left and right side sills which are provided on the floor panel together.

According to an invention set forth in Claim 16, there is provided a power control unit as set forth in Claim 5, wherein

the fixing member includes a right fixing member and a left fixing member which form a pair so as to be attached to lateral sides of the electronic component box, respectively, and

the right fixing member and the left fixing member each includes the first fixing portion and the second fixing portion.

### Advantage of Invention

According to the invention of Claim 1, the electronic component can be fixed to the vehicle body more strongly and rigidly than when the electronic component is supported only by the floor panel of the vehicle, whereby the electronic component can be disposed on the vehicle body so stably as to avoid a risk of falling. In addition, the thickness of the supporting members of the electronic component can be reduced to thereby realize a reduction in weight of the electronic component disposing construction.

In addition, in fixing the electronic component, no other widthwise space than for the members for fixing the electronic component is needed, and therefore, a sufficient space can be ensured within the passenger compartment so as to install wider seats, for example.

Further, the beam to which the steering system is fixed is supported on the floor panel via the electronic component, and therefore, the resonance of the steering system can be suppressed, thereby making it possible to reduce the weight of the beam as well.

According to the invention of Claim 2, the electronic component can be protected by the frame. In addition, the frame and the beam can be connected together by the extending portion which extends from at least one of the frame and the beam, whereby the electronic component can be fixed strongly and rigidly by the extending portion.

According to the invention of Claim 3, the frame can be fixed to the highly rigid portion of the floor panel. In addition, the frame is fixed not only at the rear lower portion of the electronic component but also at the front upper portion of the electronic component through connection to the beam, whereby the frame can be fixed to the vehicle body in the position where the fall of the electronic component is strongly resisted.

According to the invention of Claim 4, the space portion can be used effectively by accommodating the user-operable electronic component such as the car navigation unit or the audio unit in the space portion. In addition, the user-operable electronic component can be fixed strongly and rigidly.

According to the invention of Claim 5, the electronic component can be supported more strongly and rigidly than when the electronic component is supported only by the floor panel and can be disposed on the vehicle body so stably as to resist the fall thereof, whereby the thickness of the members which support the electronic component can be reduced so as to realize a reduction in weight of the electronic component disposing construction.

### BRIEF DESCRIPTION OF DRAWINGS

FIG. 1 is a schematic side view of a hybrid vehicle to which the invention is applied.

FIG. 2 is a perspective view showing an interior of a passenger compartment at a front part of the vehicle shown in FIG. 1.

FIG. 3 is a perspective view showing a state in which an instrument panel and an electronic component box cover shown in FIG. 2 are removed.

FIG. 4(a) is a perspective view showing a state in which IPU frames are attached to a steering system hanger beam and a floor panel, and FIG. 4(b) is an exploded perspective view of the IPU frames and an electronic component box.

FIG. 5 is a sectional view taken along the line V-V in FIG. 2.

FIG. 6 is a perspective view showing an in-vehicle electronic component disposing construction for an electronic component for an electric motor for driving a vehicle according to a modified example of the invention.

### MODE FOR CARRYING OUT INVENTION

Hereinafter, an in-vehicle electronic component disposing construction for an electronic component for an electric motor for driving a vehicle according to an embodiment of the invention will be described in detail by reference to the drawings.

### First Embodiment

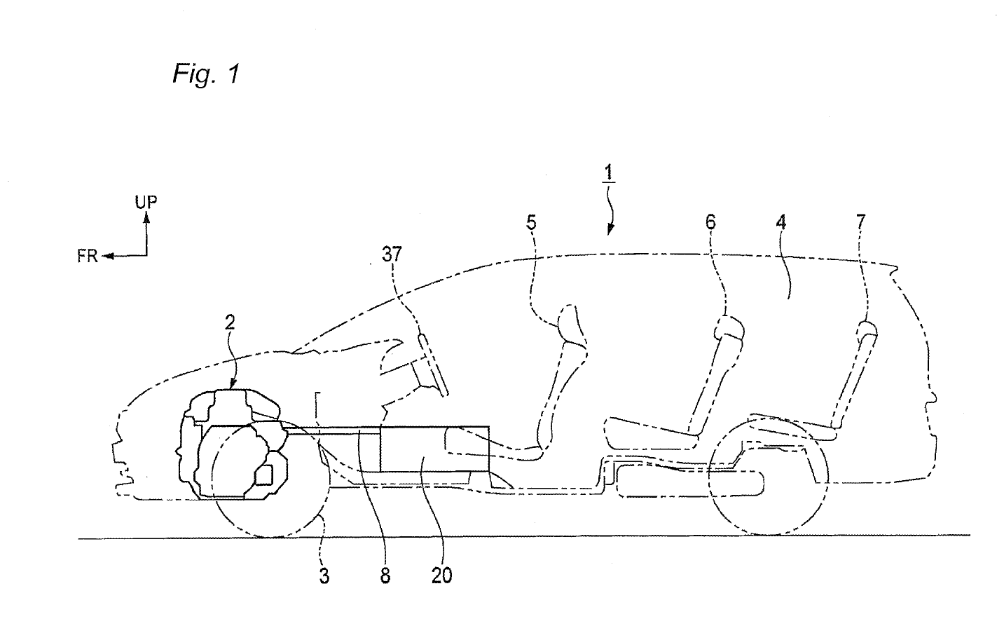

As shown in FIG. 1, a vehicle 1 of the embodiment is a hybrid vehicle which includes a power unit 2 including an engine and a motor/generator which are provided in series and in which the driving of the engine is assisted by the motor/generator and power produced in the motor/generator when the vehicle is decelerated can be recovered from the motor/generator. The motor/generator is a three-phase alternating current motor, for example, and driving forces from the engine and the motor/generator are transmitted to front wheels 3 which are driving wheels.

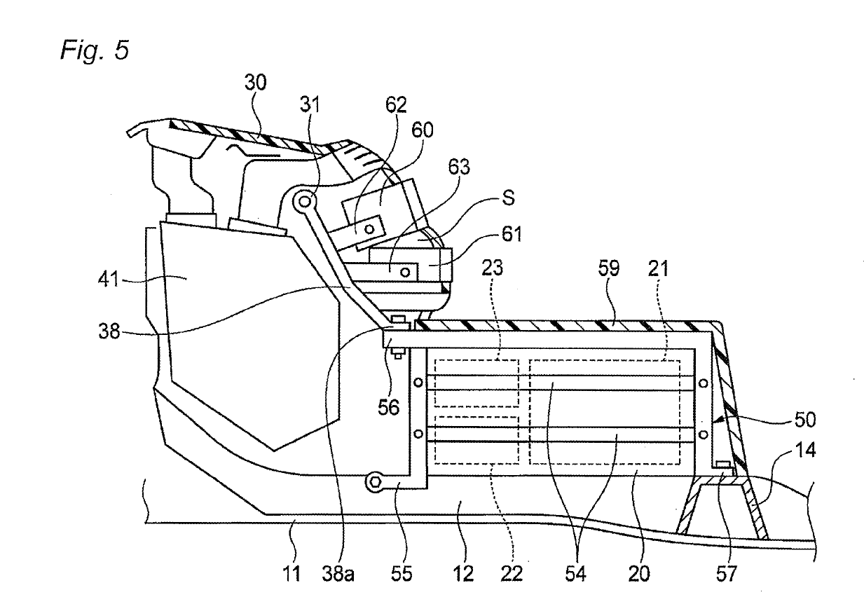

The power unit 2 is connected to an electronic component box 20 via a power cable 8. Electronic components such as a battery unit 21, an inverter unit 22 and a DC-DC converter unit 23 are incorporated in the electronic component box 20 as electronic components for an electric motor for driving the vehicle (an electric motor used mainly in running the vehicle) (refer to FIG. 5). When the motor/generator is fed from the battery unit 21 which is a direct current power supply, a direct current is converted into an alternating current by the inverter unit 22.

In addition, when an output of the engine or kinetic energy of the vehicle 1 is converted into electric energy for storage in the battery unit 21 with the vehicle 1 decelerated, the motor/generator functions as a generator to produce a so-called regenerative braking force, and the kinetic energy of the vehicle is recovered as electric energy. Electric energy so recovered is converted from an alternating current into a direct current by the inverter unit 22 for storage in the battery unit 21. In addition, a direct current voltage which is converted by the inverter unit 22 is a high voltage, and therefore, the voltage of part thereof is dropped by the DC-DC converter unit 23.

As has been described above, the electronic components incorporated in the electronic component box 20 performs various operations to control power in accordance with the running condition of the vehicle 1. Consequently, an assembly including the electronic component box 20 is also referred to as a power control unit or an intelligent power unit (IPU).

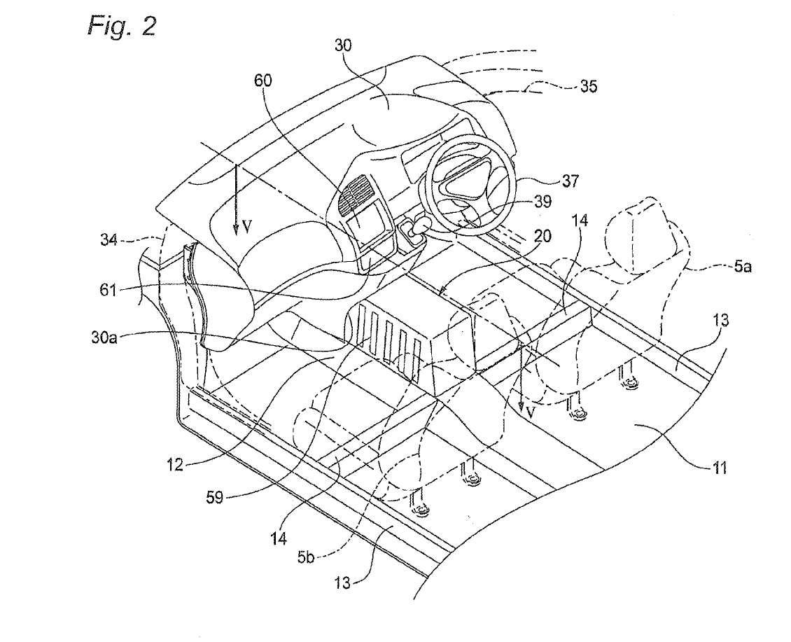

In addition, as shown in FIGS. 1 and 2, the vehicle 1 includes from the front a first row seat 5, a second row seat 6 and a third row seat 7 in a interior of a passenger compartment 4 thereof, and a driver's seat 5a and a front passenger's seat 5b which make up the first row seat 5 are disposed so as to be aligned in a widthwise or widthwise direction of the vehicle.

Further, a center tunnel 12 is formed in a floor panel 11 which makes up a floor surface of the passenger compartment 4 of the vehicle 1 so as to extend in a front-to-rear direction of the vehicle while protruding upwardly therefrom, and a section of this center tunnel 12 which is at right angles to the front-to-rear direction is open. In addition, a couple of side sills 13, 13 are formed so as to extend in the front-to-rear direction along longitudinal side edges in a widthwise direction of the vehicle, and a section of each side sill 13 which is at right angles to the front-to-rear direction is closed. Upwardly protruding cross members 14 are fixedly welded on an upper surface of the floor panel 11 so as to connect together the center tunnel 12 and the side sills 13, 13 which formed along both sides. A cross member 14 may be fixedly welded so as to extend over the center tunnel 12 to connect together the side sills 13, 13 on both sides.

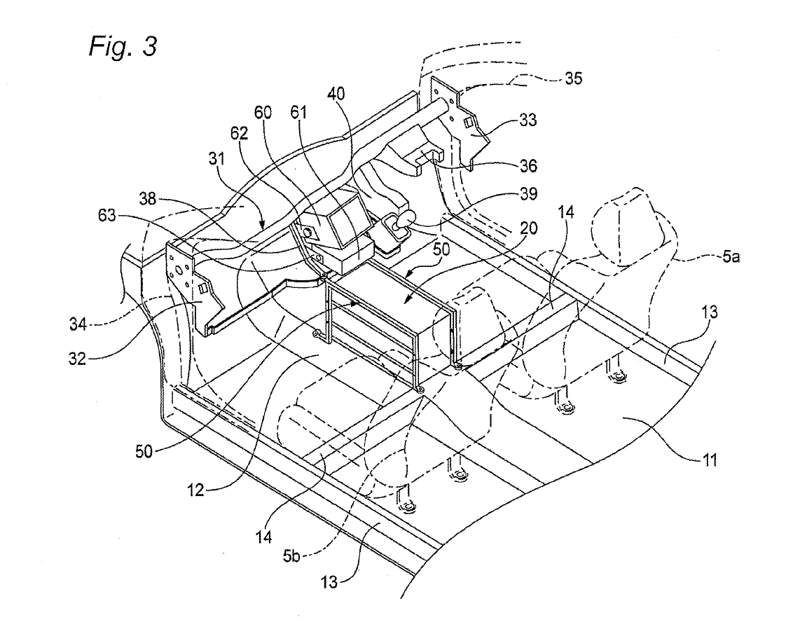

As shown in FIG. 3, a steering system hanger beam 31, extending in the widthwise direction of the vehicle, is provided within an instrument panel 30 composing a front side of the passenger compartment 4 of the vehicle 1. A couple of mounting portions 32, 33 which are individually provided at end portions of the steering system hanger beam 31 are fixed to left and right front pillars 34, 35 with bolts. A U-shaped steering system supporting portion 36 is integrally formed on the steering system hanger beam 13 in a position facing a transversely central portion of the driver's seat so as to extend rearwards. A steering system 37 for controlling the vehicle 1 is fixed to the steering system supporting portion 36 with bolts.

A couple of stays 38, 38, which are extending portions which extend obliquely downwards to the rear while kept substantially parallel to each other, are attached to a transversely central portion of the steering system hanger beam 31 through welding. Further, a lever mounting bracket 40 for mounting a shift lever 39 is attached to one of the stays 38 and the steering system supporting portion 36 through welding. As shown in FIG. 5, the couple of stays 38 are disposed to rearward of an air conditioning unit 41.

Here, the electronic component box 20 extends between the driver's seat 5a and the front passenger's seat 5b from a transversely central opening 30a (refer to FIG. 2) in the instrument panel 30 so as to be disposed on the center tunnel 12 of the floor panel 11.

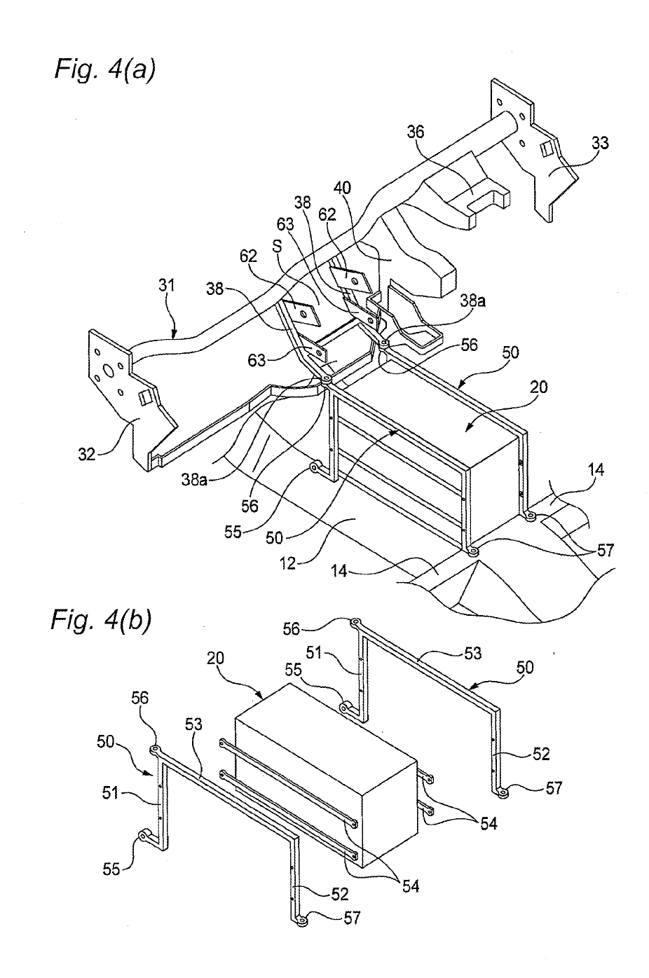

As shown in FIGS. 4 and 5, the electronic component box 20 is supported by IPU frames 50, 50 and is covered with a box cover 59. A front of the cover 59 is covered by the instrument panel 30. The box cover 59 may be composed of a center console box in which a recess portion for storing small articles and a cup holder where to rest a drink container are provided.

The couple of IPU frames 50, 50, which support the electronic component box 20, are each formed into a substantially inverted U-shape by a couple of erected portions 51, 51, 52, 52 which extend along a front edge portion and a rear edge portion, respectively, of a lateral side of the electronic component box 20 and connecting portions 53, 53 which each extends between the couple of erected portions 51, 51, 52, 52 along an upper edge portion of the lateral side of the electronic component box 20 so as to connect together the couple of erected portions 51, 51, 52, 52.

Then, front lower fastening portions (a first fixing portion: a front fixing portion) 55, 55 which are provided at lower end portions of the front erected portions 51, 51 of the IPU frames 50, 50 are fastened to the center tunnel 12 with a bolt. Front upper fastening portions (a second fixing portion) 56, 56 which extend to the front from upper end portions of the front erected portions 51, 51 are fastened, respectively, to lower end portions 38a, 38a of the couple of stays 38, 38 which extend from the steering system hanger beam 31 with a bolt. Further, rear lower fastening portions (the first fastening portion: a rear fixing portion) 57, 57 which are provided at lower end portions of the rear erected portions 52, 52 are fastened to the cross members 14 with a bolt. By this configuration, the electronic component box 20 is disposed in an interior portion defined between the IPU frames 50, 50 which are fixed to the floor panel 11. The electronic component box 20 is fixed to the vehicle body strongly and rigidly by fixing the IPU frames 50, 50 to the steering system hanger beam 31 via the couple of stays 38, 38. In addition, each of the lateral sides of the electronic component box 20 is also supported by two sub-IPU frames 54, 54 which connect together intermediate portions of the couple of elected portions 51, 51, 52, 52 of the IPU frames 50, 50.

As has been described above, each IPU frame 50 includes the erected portion (a first frame portion) 51 which connects together the front lower fastening portion (the front fixing portion) 55 and the front upper fastening portion (the second fixing portion) 56, the connecting portion (a second frame portion) 53 which extends horizontally from the front upper fastening portion (the second fixing portion) 56 to a rear upper end position of the electronic component box 20 and the erected portion (a third frame portion) 52 which is bent from the rear upper end position to extend to the rear lower fastening portion (the rear fixing portion) 57.

The front lower fastening portion (the front fixing portion) 55 includes a first bolt fastening hole which is fixed to the floor panel 11 by a first bolt being inserted thereinto in a first inserting direction. The rear lower fastening portion (the rear fixing portion) 57 includes a second bolt fastening hole which is fixed to the floor panel 11 by a second bolt being inserted thereinto in a second inserting direction which differs from the first inserting direction. In this way, by causing the bolt inserting directions in which the bolts are inserted into the first and second bolt fastening holes to differ from each other, the rigidity against inertial forces which are applied to the electronic component box 20 in various directions can be increased, thereby making it possible to suppress the brittleness to an external force applied in a specific direction.

In addition, as FIGS. 3 and 4(a) show, a space portion S is defined by the steering system hanger beam 31, the couple of stays 38, 38 and a front upper edge portion of the electronic component box 20, and a car navigation unit 60 and an audio unit 61 are disposed in this space portion S as user-operable electronic components. These car navigation unit 60 and audio unit 61 are fixed to the steering system hanger beam 31 via mounting brackets 62, 62, 63, 63 which are provided on the couple of stays 38, 38.

Thus, as has been described heretofore, according to the electronic component disposing construction of this embodiment, the electronic component box 20 which contains the electronic components for the electric motor for driving the vehicle is disposed between the driver's seat 5a and the front passenger's seat 5b and is fixed by the floor panel 11 of the vehicle and the steering system hanger beam 31 to which the steering system 37 is fixed. Because of this, the electronic component box 20 can be fixed to the vehicle body more strongly and rigidly than when the electronic component box 20 is fixed by the floor panel 11 of the vehicle 1, whereby the electronic component box 20 can be disposed on the vehicle body so stably as to resist an inertial force which attempts to turn the electronic component box 20 sideways. Consequently, the thickness of the IPU frames 50, 50 which support the electronic component box 20 can be reduced so as to realize a reduction in weight of the electronic component disposing construction.

In addition, in fixing the electronic component box 20, no other widthwise space than the space corresponding to the thickness of the IPU frames 50, 50 is needed, a sufficient space can be ensured within the passenger compartment so as to install wider seats, for example.

Further, the steering system hanger beam 31 is supported on the floor panel 11 via the electronic component box 20 and the IPU frames 50, 50, and therefore, the resonance of the steering system 37 can be suppressed, thereby making it possible to realize a reduction in weight of the steering system hanger beam 31.

In addition, in this embodiment, the electronic component box 20 is disposed in the interior defined between the IPU frames 50, 50 which are fixed to the floor panel 11, whereby the electronic components can be protected by the IPU frames 50, 50. In addition, the couple of stays 38, 38 are caused to extend from part of the steering system hanger beam 31 so that the IPU frames 50, 50 and the steering system hanger beam 31 are connected to each other, whereby the electronic component box 20 can be fixed strongly and rigidly by the couple of stays 38, 38.

Further, in this embodiment, the IPU frames 50, 50 are fixed respectively to the cross members 14, 14 which are connected to the corresponding left and right side sills 13, 13 of the floor panel 11. Therefore, the IPU frames 50, 50 can be fixed to the highly rigid portions of the floor panel 11. The IPU frames 50, 50 are fixed not only at the rear lower portions of the electronic component box 20 but also at the front upper portions of the electronic component box 20 through connection to the steering system hanger beam 31. This provides the construction in which the electronic component box 20 is supported in at least diagonal positions on the lateral sides thereof, whereby the IPU frames 50, 50 can be fixed to the vehicle body in the positions which can strongly resist the inertial force which attempts to turn the electronic component box 20 sideways.

In addition, the user-operable electronic components such as the car navigation unit 60 and the audio unit 61 are disposed in the space portion S which is defined by the steering system hanger beam 31, the couple of stays 38, 38 and the front upper edge portion of the electronic component box 20, and the user-operable electronic components are fixed to the steering system hanger beam 31 via the couple of stays 38, 38. Therefore, the space portion S can be used effectively, and the user-operable electronic components can be fixed strongly and rigidly.

In this embodiment, while the couple of stays 38, 38 are formed so as to extend from part of the steering system hanger beam 31, the stays 38, 38 may be formed so as to extend respectively from the front upper portions of the IPU frames 50, 50. Alternatively, couples of stays 38, 38 may be formed so as to extend both from the steering system hanger beam 31 and the IPU frames 50, 50 to thereby be fixed to each other at free ends thereof.

Additionally, while the rear lower portions of the IPU frames 50, 50 are fixed to the cross members 14, 14, the rear lower portions may be fixed to the center tunnel 12 of the floor panel 11 in positions lying in the vicinity of the cross members 14, 14.

The invention is not limited to the embodiment that has been described heretofore but can be modified or improved as required.

In the embodiment, the hybrid vehicle is described as the vehicle to which the invention is applied. However, the invention is not limited thereto but may be applied to an electric vehicle which uses only an electric motor as a drive source.

In this embodiment, the battery unit 21, the inverter unit 22 and the DC-DC converter unit 23 are described as being provided as the electronic components for the electric motor for driving the vehicle and the electronic component box 20 which accommodates these electronic components is described as being supported and fixed by the frames. However, for example, a configuration may be adopted in which the battery unit 21 which is the electronic component for the electric motor for driving the vehicle is directly supported and fixed by the frames.

In addition, the frames of the invention may only have to be constructed so as to support electronic components. Therefore, for example, there may be provided connecting frames which extend between a couple of frames 50, 50 so as to connect them together or a single frame member which supports both lateral sides of electronic components.

Additionally, the extending portion of the invention is not limited to the couple of stays 38, 38 but may be made up of a single support frame, provided that a user-operable electronic component can be mounted thereon.

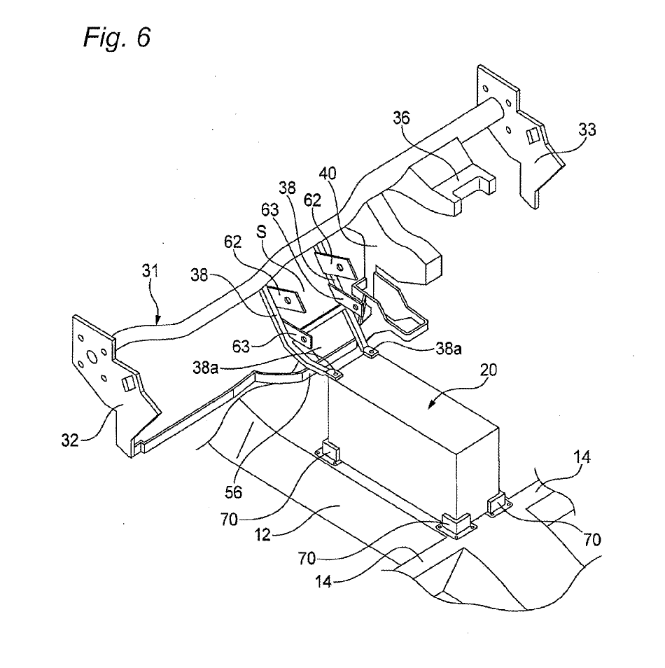

Further, as shown in FIG. 6, a configuration may be adopted in which an electronic component box 20 is fixed to a floor panel 11 by fixing members 70 which are provided at four locations thereon and lower end portions 38a, 38a of a couple of stays 38, 38 are fixed directly to the electronic component box 20.

### DESCRIPTION OF REFERENCE NUMERALS AND CHARACTER

1 vehicle

5a driver's seat

5b front passenger's seat

11 floor panel

13 side sill

14 cross member

20 electronic component box (electronic component)

21 battery unit (electronic component)

22 inverter unit (electronic component)

23 DC-DC converter unit (electronic component)

31 steering system hanger beam

37 steering system

38 stay (extending portion)

50 IPU frame

60 car navigation unit (user-operable electronic component)

61 audio unit (user-operable electronic component)

S space portion

1. An in-vehicle electronic component disposing construction comprising:
a steering system which controls a vehicle;
a driver's seat and a front passenger's seat which are placed in a passenger compartment; and
an electronic component for an electric motor for driving the vehicle which is disposed between the driver's seat and the front passenger's seat, wherein
the electronic component is supported by a floor panel of the vehicle and a beam for fixing the steering system.

2. The in-vehicle electronic component disposing construction according to claim 1, wherein
the electronic component is disposed in an interior of a frame which is fixed to the floor panel, and
the frame and the beam are fixed to each other by an extending portion which extends at least from one of part of the beam and part of the frame.

3. The in-vehicle electronic component disposing construction according to claim 2, wherein
the frame is fixed to a cross member which is connected to left and right side sills of the floor panel or fixed to a portion of a center tunnel of the floor panel which lies in a vicinity of the cross member.

4. The in-vehicle electronic component disposing construction according to claim 2, wherein
the extending portion comprises a couple of stays which extend substantially parallel to each other,
a user-operable electronic component which is to be operated by a user is disposed in a space which is defined by the beam, the couple of stays and a front upper edge portion of the electronic component for the vehicle driving electric motor, and
the user-operable electronic component is fixed to the beam via the couple of stays.

5. A power control unit which is mounted in a vehicle comprising a driving electric motor, comprising:
an electronic component for controlling the electric motor;
an electronic component box which accommodates the electronic component; and
a fixing member which fixes the electronic component box to the vehicle, wherein
the fixing member comprises a first fixing portion which is fixed to a floor panel of the vehicle in a position below the electronic component box and a second fixing portion which is fixed to a steering system hanger beam which extends in a widthwise direction of the vehicle in a position above the electronic component box.

6. The power control unit according to claim 5, wherein
the second fixing portion is fixed to the steering system hanger beam via a plurality of stays which extend downwards from a central portion of the steering system hanger beam in the widthwise direction of the vehicle.

7. The power control unit according to claim 5, wherein
the first fixing portion comprises a front fixing portion which is fixed to the floor panel in a position lying at a front of the electronic component box and a rear fixing portion which is fixed to the floor panel in a position lying at a rear of the electronic component box.

8. The power control unit according to claim 7, wherein
the fixing member comprises a frame which connects the front fixing portion, the rear fixing portion and the second fixing portion together.

9. The power control unit according to claim 8, wherein
the frame comprises a first frame portion which connects the front fixing portion and the second fixing portion together, a second frame portion which extends horizontally from the second fixing portion to a rear upper end position of the electronic component box, and a third frame portion which is bent from the rear upper end position to extend to the rear fixing portion.

10. The power control unit according to claim 9, wherein
the fixing member comprises a sub-frame which connects the first frame portion and the third frame portion together.

11. The power control unit according to claim 8, wherein
the front fixing portion comprises a first bolt fastening hole which is fixed to the floor panel by a first bolt being inserted thereinto in a first inserting direction, and
the rear fixing portion comprises a second bolt fastening hole which is fixed to the floor panel by a second bolt being inserted thereinto in a second inserting direction which differs from the first inserting direction.

12. The power control unit according to claim 5, wherein
the electronic component box is placed on the floor panel in such an orientation that a longitudinal direction of the electronic component box coincides with a front-to-rear direction of the vehicle.

13. The power control unit according to claim 12, wherein
the electronic component box is placed on a center tunnel which is formed along the front-to-rear direction of the vehicle in a central position of the floor panel in the widthwise direction of the vehicle.

14. The power control unit according to claim 13, wherein
the first fixing portion is fixed to the center tunnel which is formed on the floor panel.

15. The power control unit according to claim 14, wherein
the first fixing portion is fixed to the center tunnel in a position lying in a vicinity of a cross member which connects together left and right side sills which are provided on the floor panel.

16. The power control unit according to claim 5, wherein
the fixing member comprises a right fixing member and a left fixing member which form a pair so as to be attached to lateral sides of the electronic component box, respectively, and
the right fixing member and the left fixing member each comprises the first fixing portion and the second fixing portion.

17. The in-vehicle electronic component disposing construction according to claim 3, wherein
the extending portion comprises a plurality of stays which extend substantially parallel to each other,
a user-operable electronic component which is to be operated by a user is disposed in a space which is defined by the beam, the plurality of stays and a front upper edge portion of the electronic component for the vehicle driving electric motor, and
the user-operable electronic component is fixed to the beam via the plurality of stays.
